(19) United States
(12) Patent Application Publication
(10) Pub. No.: US 2007/0252928 A1
(43) Pub. Date: Nov. 1, 2007

(54) Structure, transmission type liquid crystal display, reflection type display and manufacturing method thereof

(75) Inventors: Manabu Ito, Tokyo (JP); Norimasa Sekine, Tokyo (JP); Mamoru Ishizaki, Tokyo (JP); Osamu Kina, Tokyo (JP); Ryohei Matsubara, Tokyo (JP)

Correspondence Address: SQUIRE, SANDERS & DEMPSEY L.L.P., 1 MARITIME PLAZA, SUITE 300, SAN FRANCISCO, CA, 94111, US

(73) Assignee: Toppan Printing Co., Ltd., Tokyo (JP)

(21) Appl. No.: 11/786,494

(22) Filed: Apr. 11, 2007

(30) Foreign Application Priority Data
Apr. 28, 2006 (JP) 2006-124881
Apr. 28, 2006 (JP) 2006-124885

(51) Int. Cl. G02F 1/1335

(52) U.S. Cl. 349/106; 349/113

(57) ABSTRACT

A method of manufacturing a transmission type liquid crystal display is disclosed including preparing a color filter; forming a substantially transparent semiconductor circuit on a surface of the color filter while position adjustment between the color filter and the semiconductor circuit is performed; and forming a transmission type liquid crystal display element on one side of the substantially transparent semiconductor circuit, wherein there is no color filter on the one side.

### CROSS REFERENCE

This application claims priority to Japanese application number 2006-124881, filed on Apr. 28, 2006, and priority to Japanese application number 2006-124885, filed on Apr. 28, 2006, which are incorporated herein by reference.

### BACKGROUND OF THE INVENTION

1. Field of the Invention

The present invention is related to a structure, a transmission type liquid crystal display, a reflection type display and manufacturing method thereof

2. Description of the Related Art

Generally a thin film transistor uses amorphous silicon or polysilicon as a driving transistor of electronic devices such as display units.

However, because amorphous silicon and polysilicon were opaque and had photo sensitivity in a visible light range, a light-shielding film was necessary.

Therefore, because visibility was influenced by the semiconductor circuit which consisted of a thin film transistor and an electric wiring (in the following, it is referred to as semiconductor circuit), the semiconductor circuit have been installed in the backside of a display unit.

In addition, a color filter is generally used in colorization of a transmission type liquid crystal display. A liquid crystal sealing layer is formed between a color filter and a thin film transistor substrate for the above mentioned reason (Japanese Patent Laid-Open No. 9-73082 Official Gazette).

In addition, a color filter is generally used in colorization of a reflection type display such as a reflection type liquid crystal display or an electrophoretic display unit. A liquid crystal sealing layer and an electrophoretic particle layer are formed between a color filter and a thin film transistor substrate for the above mentioned reason (Japanese Patent Laid-Open No. 2005-224948 Official Gazette).

However, in the case of a liquid crystal display, when a color filter and a semiconductor circuit substrate are formed at this position, it is necessary to perform position adjustment between a color filter and a semiconductor circuit substrate while there is a liquid crystal between a color filter and a semiconductor circuit substrate.

Therefore, it is difficult to achieve high accuracy. Cost rises, and yield falls.

The present invention was made in the light of such a consideration.

The present invention provide structure, transmission type liquid crystal display, reflection type display and manufacturing methods thereof, wherein position adjustment between semiconductor circuit and color filter is easy.

In addition, in the present invention, a color filter having a semiconductor circuit is referred to as a structure.

### SUMMARY OF THE INVENTION

One embodiment of the present invention is disclosed. A manufacturing method of transmission type liquid crystal display comprising the following structure: preparing a color filter; forming a substantially transparent semiconductor circuit on a surface of the color filter while position adjustment between the color filter and the semiconductor circuit is performed; and forming a transmission type liquid crystal display element on a opposite surface of the semiconductor circuit where the color filter is not formed.

### BRIEF DESCRIPTION OF DRAWINGS

FIG. 1 is a schematic cross-sectional view of a transmission type liquid crystal display of an embodiment of the present invention.

FIG. 2 is a section view of one part of a transmission type liquid crystal display of an embodiment of the present invention.

FIG. 3 is a partial cross section for approximately 1 pixel of a reflection type display of an embodiment of the present invention.

FIG. 4 is a schematic cross-sectional view of a reflection display of an embodiment of the present invention.

FIG. 5 is a schematic cross-sectional view of a reflection display of an embodiment of the present invention.

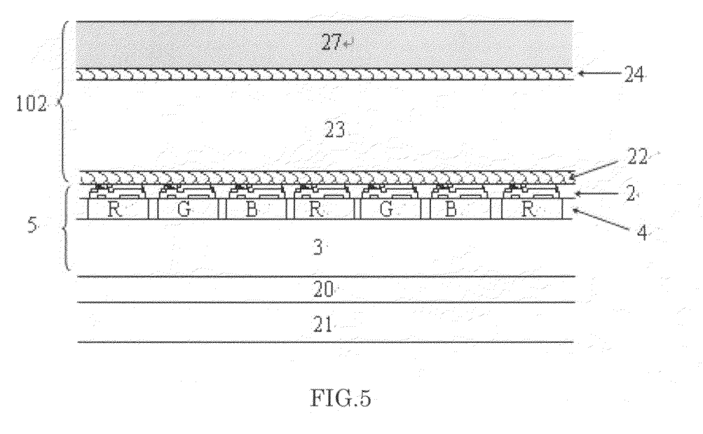

FIG. 6 is a partial cross section for approximately 1 pixel of a reflection type display of an embodiment of the present invention.

FIG. 7 is a schematic cross-sectional view of a reflection display of an embodiment of the present invention.

FIG. 8 is a chart which shows transmittance of a red subpixel with and without a transparent TFT.

FIG. 9 is a chart which shows transmittance of a green subpixel with and without a transparent TFT.

FIG. 10 is a chart which shows transmittance of a blue subpixel with and without a transparent TFT.

FIG. 11 is a chart which shows transmittance of a white subpixel with and without a transparent TFT.

FIG. 12 is a section view of one part of a transmission type liquid crystal display of an embodiment of the present invention.

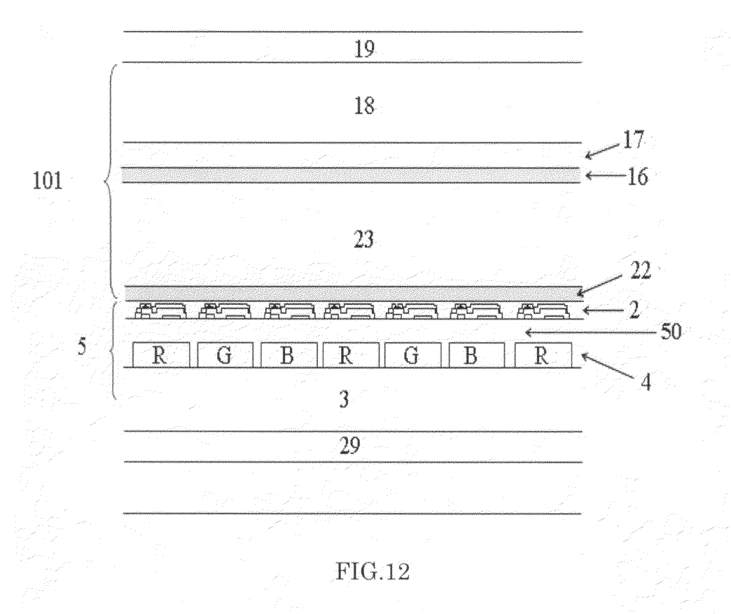

In these drawings, 2 is a substantially transparent Semiconductor circuit; 3 is a substantially transparent substrate; 4 is a color filter; 5 is a first substrate; 6 is a gate electrode; 7 is an auxiliary capacitor electrode; 8 is a gate insulator; 9 is a source electrode; 10 is a drain electrode; 11 is a semiconductor active layer; 12 is an interlayer dielectric; 13 is a pixel electrode; 14 is a common electrode; 15 is a liquid crystal; 16 is an oriented film 2; 17 is a common electrode; 18 is a substantially transparent substrate for liquid crystal display element; 19 is a polarizer 2; 20 is a phase difference plate; 21 is a polarizing film; 22 is an oriented film 1; 23 is a liquid crystal; 24 is an oriented film 2; 25 is a common electrode; 26 is a substrate for reflection type display element; 27 is a conductive substrate; 28 is an oriented film 1; 29 is a polarizer 1; 31 is an insulator layer 1; 32 is an air space; 33 is a rib; 34 is a white color particle; 35 is a black color particle; 36 is an insulator layer 2; 37 is an electrode; 38 is a substrate for reflection display front board 2; 50 is a overcoat; 101 is an transmission type liquid crystal display element; and 102 is a reflection type display element.

### DESCRIPTION OF THE PREFERRED EMBODIMENTS

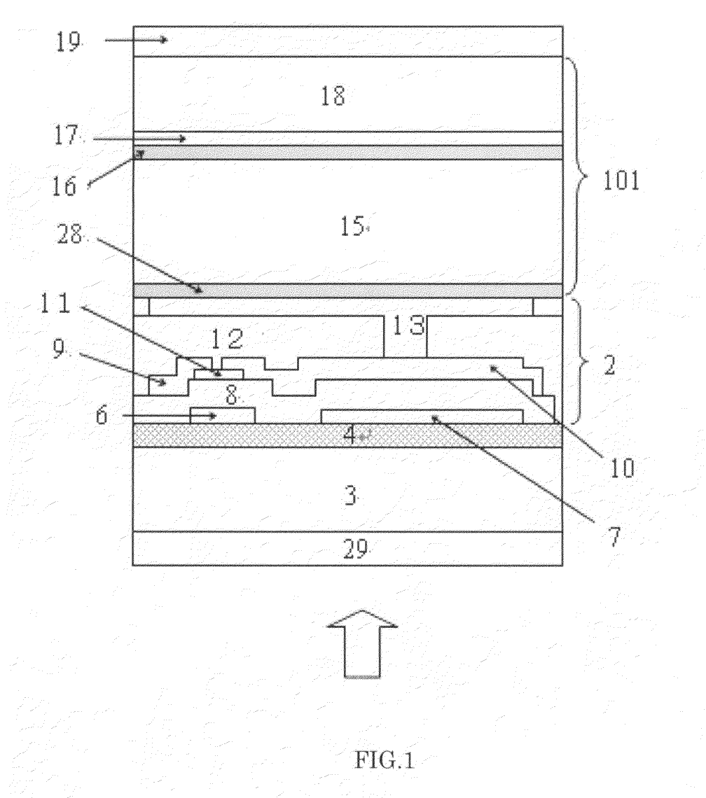

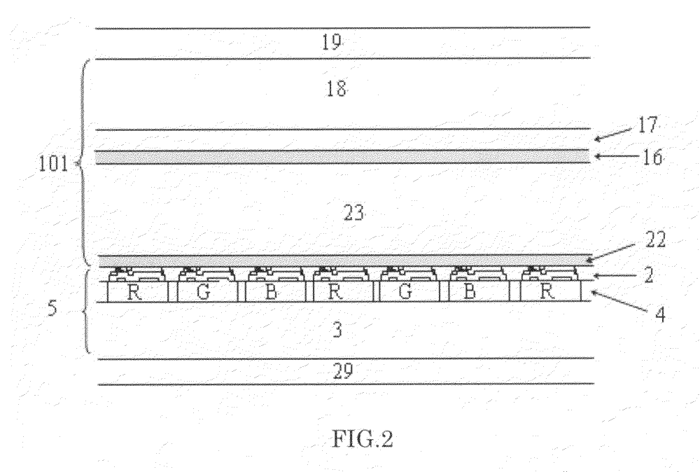

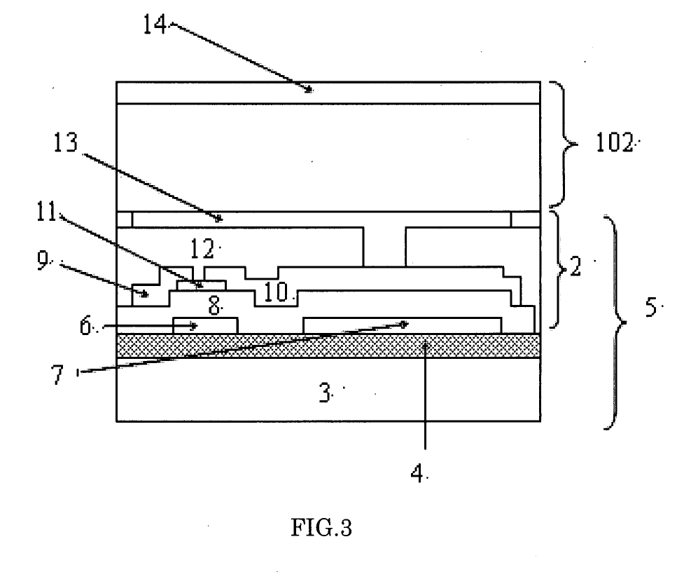

One embodiment of the present invention is shown in FIG. 1 and FIG. 2. One embodiment of the present invention is shown in FIG. 3. FIG. 3 is a partial cross section for approximately 1 pixel of a reflection type display of the present invention.

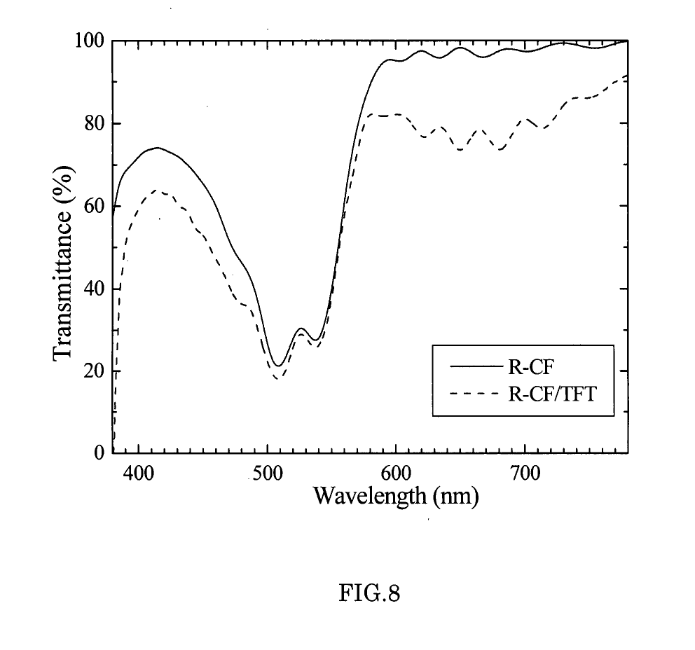

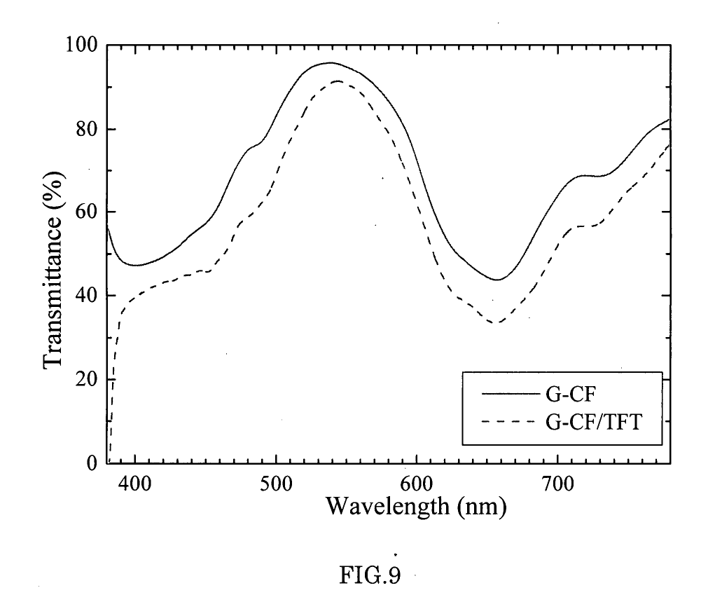

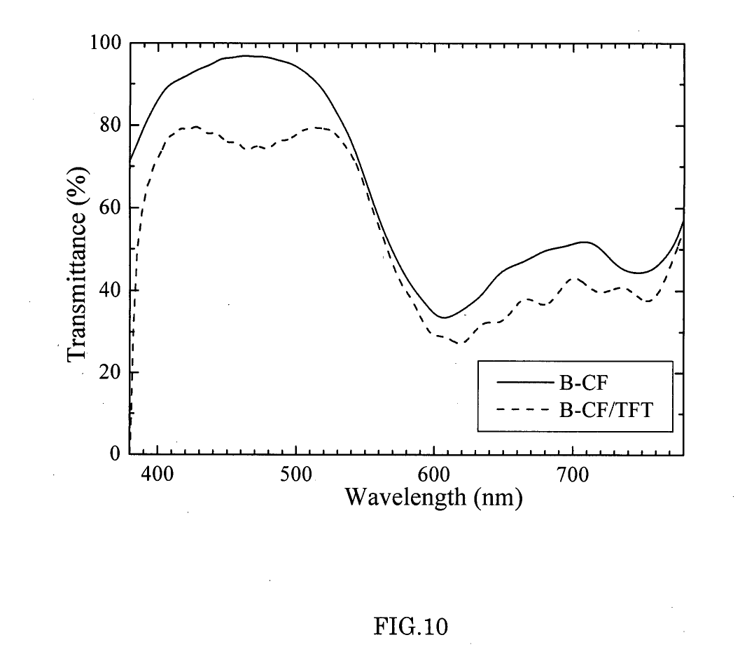

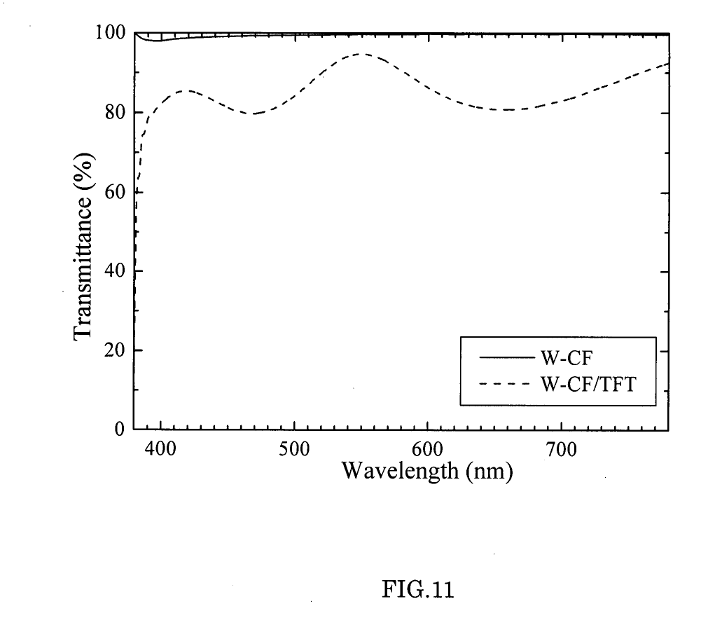

Color filter, substrate 3 on which a substantially transparent semiconductor circuit is formed, and a substrate 18 for liquid crystal display element should be substantially transparent. In one embodiment, “substantially transparent” means a state where transmittance is equal to or more than 70% in wavelength region 400 nm-700 nm that are visible light. A concrete example is shown. Transmittance was measured using microscopic spectrometry apparatus Olympus, OSP-SP200. After having measured transmittance of each colored subpixel of a color filter, a transparent TFT was formed on a color filter. Data of transmittance are shown in FIGS. 8-11. There was not great difference between transmittance of only color filter and transmittance of the color filter which comprised a transparent TFT. It is found that transparent TFT of the present invention does not greatly influence visibility of a display.

For substrate, polymethyl methacrylate, acrylics, polycarbonate, polystyrene, polyethylen sulfide, polyethersulfone, polyolefin, polyethylene terephthalate, polyethylenenaphthalate, cyclo-olefin polymers, polyether sulfone, triacetylcellulose, polyvinyl fluoride film, ethylene-tetrafluoroethylene copolymer resin, weatherable polyethylene terephthalate, weatherable polypropylene, glass fiber-reinforced acryl resin film, glass fiber-reinforced polycarbonate, transparent polyimide, fluorinated resin, cyclic polyolefin resin, glass and quartz can be used concretely.

A substrate comprising only one material among above mentioned materials can be used, but a composite substrate comprising two or more materials among above mentioned materials can be used.

Substrate may be flexible or may be rigid.

In addition, when a substrate is an organic film, it is preferable to form a transparent gas barrier layer in order to raise the durability of an element. Al₂O₃, SiO₂, SiN, SiON, SiC, diamondlike carbon (DLC) or the like can be used for a gas barrier layer, but usable materials are not limited to these materials. In addition, a gas barrier layer may comprise two or more layers. In addition, a gas barrier layer may be formed only on one side of an organic film substrate, and it may be formed on both sides.

A gas barrier layer can be formed by evaporation method, ion plating method, sputter method, laser ablation method, plasma CVD (Chemical Vapor Deposition) method, hot wire CVD method and sol-gel process, but usable methods are not limited to these methods.

For a gate electrode, a source electrode, a drain electrode, an auxiliary capacitor electrode, a pixel electrode, a scanning line electrode and a signal line electrode used for a substantially transparent semiconductor of the present invention and for a common electrode of a transmission type liquid crystal display element, oxide materials such as indium oxide (In2O₃), tin oxide (SnO₂), zinc oxide (ZnO), cadmium oxide (CdO), cadmium indium oxide (CdIn₂O₄), cadmium tin oxide (Cd₂SnO₄), zinc tin oxide (Zn₂SnO₄) and indium zinc oxide (In—Zn—O) can be used.

In addition, these materials doped with impurity are preferably used. For example, indium oxide doped with tin (Sn), molybdenum (Mo) or titanium (Ti), tin oxide doped with antimony (Sb) or fluorine (F), zinc oxide doped with indium, aluminium and gallium (Ga) can be used. Among these doped materials, indium tin oxide (common name ITO) which is indium oxide doped with tin (Sn) is preferable used, because ITO has high transparency and low electrical resistivity.

In addition, electrode having plural layers comprising above mentioned conductive oxide material and metal thin film such as Au, Ag, Cu, Cr, Al, Mg and Li can be used. For this case, in order to prevent oxidation and time degradation of metallic material, three-layer structure, that is, conductive oxide thin film/metallic thin film/conductivity oxide thin film, is preferable used. In addition, a metallic thin film layer should be as thin as possible, not to disturb visibility of display unit by light reflection and light absorption at a metallic thin film layer. To be concrete, it is desirable to be 1 nm-20 nm.

In addition, organic conducting materials such as PEDOT (polyethylen dihydroxy thiophen) can be preferably used.

As for a gate electrode, a source electrode, a drain electrode, an auxiliary capacitor electrode, a pixel electrode, a scanning line electrode, a signal line electrode and a common electrode, materials of them may be identical or all of the materials may be different from each other.

In addition, in order to reduce the number of the processes, it is preferable that materials of a gate electrode and an auxiliary capacitor electrode are identical and materials of a source electrode and a drain electrode are identical.

These transparent electrodes can be formed by vacuum evaporation method, ion plating method, sputter method, laser ablation method, plasma CVD technique, photo-CVD, hot wire CVD method, screen printing, relief printing, ink jet method, but usable methods are not limited to these methods.

As a substantially transparent semiconductor active layer used for a display of the present invention, oxide semiconducting materials or organic semiconductor materials can be preferably used.

As oxide semiconductor materials, well-known materials such as zinc oxide, indium oxide, indium zinc oxide, tin oxide, tungsten oxide (WO) and zinc gallium indium oxide (In—Ga—Zn—O) which are oxides including one or more element among zinc, indium, tin, tungsten, magnesium and gallium can be used, but usable oxides are not limited to these oxides.

It is desirable that these materials are substantially transparent and the band gab is equal to or more than 2.8 eV, more preferable is equal to or more than 3.2 eV.

Structure of these materials may be monocrystal, polycrystal, crystallite, mixed crystal of crystal/amorphous, nanocrystals embedded in amorphous or amorphous.

As for the film thickness of a semiconductor layer, it is preferable to be equal to or more than 20 nm.

The oxide semiconductor layer can be formed by sputter method, pulsed laser deposition, vacuum evaporation method, CVD method, MBE (Molecular Beam Epitaxy) method and sol-gel process, however sputter method, pulsed laser deposition, vacuum evaporation method and CVD method are preferably used.

For sputter method, RF magnetron sputtering technique and DC sputter method can be used, for vacuum deposition, heating evaporation, electron beam evaporation and ion plating method can be used, and for CVD method, hot wire CVD method and plasma CVD technique can be used, but usable methods are not limited to these methods.

For organic semiconductor materials, acene such as pentacene or tetracene, naphthalene tetracarboxylic dianhydride (NTCDA) and naphthalene tetracarboxylic acid diimide (NTCDI) or conjugated polymers such as polythiophene, polyaniline, poly-p-phenylenevinylene, polyacetylene, polydiacetylene and polythienylen vinylene can be used, but usable materials are not limited to these materials.

It is desirable that these materials are substantially transparent and the band gab is equal to or more than 2.8 eV, more preferable is equal to or more than 3.2 eV.

These organic semiconductor materials are formed by screen printing, inversion type printing, ink jet process, spin coat, dip coat and evaporation method, but usable methods are not limited to these methods.

Material used for gate insulator 8 of thin film transistor used in the present invention is not limited especially, and inorganic materials such as silicon oxide, silicon nitride, silicon oxy nitride (SiNxOy), aluminium oxide, tantalum oxide, yttria, hafnium oxide, hafnium aluminates, oxidation zirconia, titanium oxide or polyacrylates such as PMMA (polymethyl methacrylate), PVA (polyvinyl alcohol), PS (polystyrene), transparent polyimide, polyester, epoxy, poly vinylphenol and polyvinyl alcohol can be used.

In order to control a gate leak current, electrical resistivity of insulating materials should be equal to or more than 10¹¹ Ωcm, and more preferably it should be equal to or more than 10¹⁴ Ωcm.

An insulator layer can be formed by vacuum evaporation method, ion plating method, sputter method, laser ablation method, plasma CVD technique, photo-CVD, hot wire CVD method, spin coat, dip coat screen printing or the like. It is desirable for thickness of an insulator layer to be 50 nm-2 μm. These gate insulators may be used as monolayer. In addition, it may have plural layers. In addition, as for the gate insulator, a composition may slope toward growth direction of the film.

Structure of thin film transistor used in the present invention is not limited especially.

It may be bottom contact type or a top contact type.

But, when an organic semiconductor is used, a bottom contact type, wherein a gate electrode, a gate insulator, a source electrode and a drain electrode, an organic semiconductor are formed in this order, is preferable. The reason is why a semiconductor layer is damaged in a case where an organic semiconductor layer is exposed to plasma in a process after an organic semiconductor is formed.

In addition, the following processes are preferably used in order to raise an aperture ratio: interlayer dielectric 12 is provided on a thin film transistor used in the present invention; and pixel electrode 13 is provided on interlayer dielectric 12, wherein pixel electrode 13 is electrically connected to pixel electrodes 13.

Interlayer dielectric 12 should be substantially transparent and have insulating properties.

For example, inorganic materials such as silicon oxide, silicon nitride, silicon oxy nitride (SiNxOy), aluminium oxide, tantalum oxide, yttria, hafnium oxide, hafnium aluminates, zirconia oxide and titanium oxide, and polyacrylates such as PMMA (polymethyl methacrylate), PVA. (polyvinyl alcohol), PS (polystyrene), transparent polyimide, polyester, epoxy, poly vinylphenol, polyvinyl alcohol or the like can be used, but usable materials are not limited to these materials.

An interlayer dielectric may be formed by same material as a gate insulator, and it may be formed by a material different from a gate insulator.

These interlayer dielectrics may be used as monolayer, and these interlayer dielectrics comprising plural layers may be used.

In the case of an element of a bottom gate structure, a protection film covering a semiconductor layer is preferably formed. A protective film can prevent a semiconductor layer from changing with time due to humidity and can prevent a semiconductor layer from being influenced by an interlayer dielectric.

As a protection film, inorganic materials such as silicon oxide, silicon nitride, silicon oxy nitride (SiNxOy), aluminium oxide, tantalum oxide, yttria, hafnium oxide, hafnium aluminates, zirconia oxide, titanium oxide, and, polyacrylates such as PMMA (polymethyl methacrylate), PVA (polyvinyl alcohol), PS (polystyrene), transparent polyimide, polyester, epoxy, poly vinylphenol, polyvinyl alcohol and fluorinated resin can be used, but usable materials are not limited to these materials.

These protection films may be used as monolayer, and these protection films comprising plural layers may be used.

In the present invention, a pixel electrode must electrically connect with a drain electrode of thin film transistor.

A concrete embodiment is illustrated below.

Interlayer dielectric in a part of drain electrode is not formed by forming pattern-shaped interlayer dielectric by method such as screen printing.

After having applied interlayer dielectric to whole area, hole is formed in interlayer dielectric by laser beam.

It is desirable that transmission type color filter 4 used in the present invention comprises three filters, that is, red filter (R), green filter (G) and blue color filter (B), or, red filter (R), green filter (G), blue color filter (B) and a black matrix (BM). But structure of transmission type color filter 4 used in the present invention is not limited these structures. Color filter 4 used in the present invention may be formed by red color filter (R), green color filter (G), blue color filter (B) and white color filter (W).

In other words, transmission type color filter is formed on one side of a substantially transparent plate substrate. And a red filter, a green filter and a blue filter are regularly arranged.

As for the color filter's colored layer, each color filter (R, G, B or R, G, B, W) is patterned like the form of stripe matrix of a predetermined width or the form of rectangle matrix of a predetermined size.

In addition, after forming a coloring pattern, a transparent overcoat 50 is preferably formed on a color filter layer in order to protect a coloring pattern and to lower unevenness of a color filter layer.

A substantially transparent semiconductor circuit of the present invention is formed on a surface of a color filter while position adjustment is performed.

To be concrete, it is desirable to form alignment marks in a place but a picture element when each coloring pattern of a color filter is formed.

When a substantially transparent semiconductor circuit is patterned, it is desirable that position adjustment between alignment marks of color filter's coloring pattern and alignment marks of a photo mask for a substantially transparent semiconductor circuit (for example, gate electrode, capacitor electrode, semiconductor active layer, source/drain electrode and pixel electrode) is performed.

In addition, it is desirable that a substantially transparent semiconductor circuit is formed at film formation temperature of less than or equal to 250 degrees Celsius (more preferably, less than or equal to 200 degrees Celsius).

When the film formation temperature rises more than the above mentioned temperature, a color filter layer may be damaged by heat, deterioration of color, dimensional deformation and film peeling of each picture element may occur, and reliability as a display may be lowered.

In addition, after forming gate electrode/capacitor electrode, source/drain electrode and pixel electrode at low temperature, it is desirable to anneal them at 150-200 degrees Celsius in order to raise transparency.

According to the current invention, because a substantially transparent semiconductor circuit is formed on a color filter on a substantially transparent substrate, and the members are arranged in front of a transmission type liquid crystal display element, position adjustment between a color filter and a semiconductor circuit becomes easier without affecting visibility and a manufacturing cost is reduced.

In addition, according to the current invention, because a substantially transparent semiconductor circuit is formed on a color filter on a substantially transparent substrate, and the members are arranged in front of a reflection type display element, position adjustment between a color filter and a semiconductor circuit becomes easier without affecting visibility and a manufacturing cost is reduced.

In addition, two substrates, that is, a substrate for a color filter and a substrate for a semiconductor circuit were necessary in conventional transmission type liquid crystal display.

However, only one substrate is necessary in a transmission type display of the present invention. Therefore, a cost of substrate can be reduced. In addition, picture display unit lightens.

Here, a transmission type liquid crystal display element means a structure comprising an oriented film/a liquid crystal/an oriented film/a common electrode/a substantially transparent substrate.

In addition, two substrates, that is, a substrate for a color filter and a substrate for a semiconductor circuit were necessary in conventional reflection type display.

However, only one substrate is necessary in a reflection type display of the present invention. Therefore, a cost of substrate can be reduced. In addition, picture display unit lightens.

### EXAMPLE 1

Sectional drawings of example 1 are shown in FIG. 1 and FIG. 2. FIG. 1 is a partial cross section for approximately 1 pixel of a transmission type display of an example of the present invention. FIG. 2 is a section view of a transmission type liquid crystal display of an example of the present invention.

For substantially transparent plate substrate 3, alkali-free glass 1737 (thickness 0.5 mm) made in Corning were used. Color filter layer 4 comprising R (red), G (green) and B (blue) was formed on one side of the substrate. Thereupon, a protective layer comprising a transparent resin was formed.

Then, ITO thin film of 50 nm thickness was formed over color filter layer 4 by DC magnetron sputtering technique. And, the ITO thin film was patterned into a desired shape while position adjustment between the patterned ITO thin film and a color filter layer was performed. In this way, gate electrode 6 and auxiliary capacitor electrode 7 were formed.

Further, using a target of silicon nitride (Si₃N₄), SiON thin film of 150 nm thickness was formed thereupon by RF sputter method. Gate insulator 8 was formed in this way.

Further, in order to form semiconductor active layer 11, amorphous In—Ga—Zn—O thin film of 40 nm thickness was formed by RF sputter method using an InGaZnO₄ target. Then semiconductor active layer 11 was patterned into a desired shape.

Resist was applied thereupon, drying and developing were performed. Subsequently ITO film of thickness 50 nm was formed by DC magnetron sputtering technique. Lift-off was performed, and source electrode 9 and drain electrode 10 were formed.

Further, by a printing method, pattern of an epoxy system resin of thickness 5 μm was formed, that is, interlayer dielectric 12 was formed.

And finally, ITO film of thickness 100 nm was formed by magnetron sputtering technique. By patterning of ITO film, pixel electrode 13 was formed.

The semiconductor circuit comprising a substantially transparent thin film transistor and an electric wiring made of substantially transparent conductive material, wherein the wiring had an electrical contact connecting to the thin film transistor, was formed over a color filter while position adjustment between the semiconductor circuit and the color filter's pattern was performed.

A condition of making each film is shown in table 1.

Oriented film 22 was applied on a substantially transparent semiconductor circuit made in this way. In addition, oriented film 24 was applied on alkali-free glass 1737 (thickness 0.5 mm) made in Corning, on which ITO thin film of 70 nm thickness was formed as a common electrode. And the glass with ITO was placed on the substrate with the thin film transistor through a spacer. Then, a liquid crystal is filled between the spacers.

Finally, by placing phase difference plate 20 and polarizer 21 on one side of a substantially transparent substrate 3 where the color filter was not formed, a display of example 1 was manufactured.

Therefore, a display comprises a substantially transparent substrate, a color filter, a semiconductor circuit including a substantially transparent thin film transistor and an electric wiring made of a substantially transparent conductive material, wherein the wiring had an electrical contact with the transistor, and a transmission type liquid crystal display element in this order. In addition, the substantially transparent substrate is placed at a front face side of a display.

TABLE 1

| | | Flow rate | Flow rate | Working | |
|---|---|---|---|---|---|
| | | of Ar | of O₂ | pressure | Input power |
| | Target | [SCCM] | [SCCM] | [Pa] | [W] |
| Gate electrode and | SnO₂: 5 wt. % - | 10 | 0.3 | 0.5 | 200 |
| auxiliary capacitor | In₂O₃ | | | | |
| electrode | | | | | |
| Gate insulator | Si₃N₄ | 40 | 2 | 0.5 | 200 |
| Semiconductor active | InGaZnO₄ | 10 | 0.2 | 0.5s | 200 |
| layer | | | | | |
| Source and Drain | SnO₂: 5 wt. % - | 10 | 0.3 | 0.5 | 200 |
| electrodes | In₂O₃ | | | | |
| Pixel electrode | SnO₂: 5 wt. % - | 10 | 0.2 | 1.0 | 50 |
| | In₂O₃ | | | | |

### EXAMPLE 2

Sectional drawings of an example are shown in FIG. 1 and FIG. 2. FIG. 1 is a partial cross section for approximately 1 pixel of a transmission type display of an example of the present invention. FIG. 2 is a section view of a transmission type liquid crystal display of an example of the present invention.

For substantially transparent plate substrate 3, alkali-free glass 1737 (thickness 0.5 mm) made in Corning were used. Color filter layer 4 comprising R (red), G (green) and B (blue) was formed on one side of the substrate. Thereupon, a protective layer comprising a transparent resin was formed.

Then, ITO thin film of 50 nm thickness was formed over color filter layer 4 by DC magnetron sputtering technique. And, the ITO thin film was patterned into a desired shape while position adjustment between the patterned ITO thin film and a color filter layer was performed. In this way, gate electrode 6 and auxiliary capacitor electrode 7 were formed.

Further, using a target of silicon nitride (Si₃N₄), SiON thin film of 150 nm thickness was formed thereupon by RF sputter method. Gate insulator 8 was formed in this way.

Further, ZnO thin film of 40 nm thickness was formed by an RF sputter method intentionally using the ZnO target without a dopant in order to form semiconductor active layers 11. ZnO thin film was patterned into a desired shape. Resist was applied thereupon, and drying and developing were performed. Subsequently ITO film of 50 nm thickness was formed by DC magnetron sputtering technique. By a lift-off, source electrode 9 and drain electrode 10 was formed.

Further, a pattern of epoxy system resin of 5 μm thickness was formed by a printing method. Interlayer dielectric 12 was formed in this way.

And finally, ITO film of 10 nm thickness was formed by magnetron sputtering technique. By patterning of ITO film, pixel electrode 13 was formed.

The semiconductor circuit comprising a substantially transparent thin film transistor and an electric wiring made of substantially transparent conductive material, wherein the wiring had an electrical contact connecting to the thin film transistor, was formed over a color filter while position adjustment between the semiconductor circuit and the color filter's pattern was performed. A condition of making each film is shown in table 2.

Oriented film 22 was applied on a substantially transparent semiconductor circuit made in this way. As conductive substrate 27, tinfoil (thickness 25 μm) was further prepared. Oriented film 24 was applied on the tinfoil.

The substrate with the semiconductor circuit was placed over this tinfoil through a spacer. Liquid crystal was filled between the spacers afterwards.

Finally, phase difference plate 20 and polarizer 21 were placed over one side of a substantially transparent substrate, where a color filter was not formed. In this way, a display of example 2 was manufactured.

Therefore, a display comprises a substantially transparent substrate, a color filter, a semiconductor circuit including a substantially transparent thin film transistor and an electric wiring made of a substantially transparent conductive material, wherein the wiring had an electrical contact with the transistor, and a transmission type liquid crystal display element in this order. In addition, the substantially transparent substrate is placed at a front face side of a display.

TABLE 2

| | | Flow rate of | Flow rate of | Working | Input |
|---|---|---|---|---|---|
| | | Ar | O₂ | pressure | power |
| | Target | [SCCM] | [SCCM] | [Pa] | [W] |
| Gate electrode and | SnO₂: 5 wt. % - | 10 | 0.3 | 0.5 | 200 |
| auxiliary capacitor | In₂O₃ | | | | |
| electrode | | | | | |
| Gate insulator | Si₃N₄ | 40 | 2 | 0.5 | 200 |
| Semiconductor active | ZnO | 12 | 0.1 | 0.5 | 200 |
| layer | | | | | |
| Source and Drain | SnO₂: 5 wt. % - | 10 | 0.3 | 0.5 | 200 |
| electrodes | In₂O₃ | | | | |

As shown in example 1 and example 2, a substantially transparent semiconductor circuit was formed on a substantially transparent substrate, and the members were placed in front of a transmission type liquid crystal display element.

Therefore, unlike prior art, there is no liquid crystal between a semiconductor circuit and a color filter. Thus, a transmission type display, wherein manufacturing cost is low and position adjustment between a color filter and a semiconductor circuit is easy without affecting visibility, can be obtained.

### EXAMPLE 3

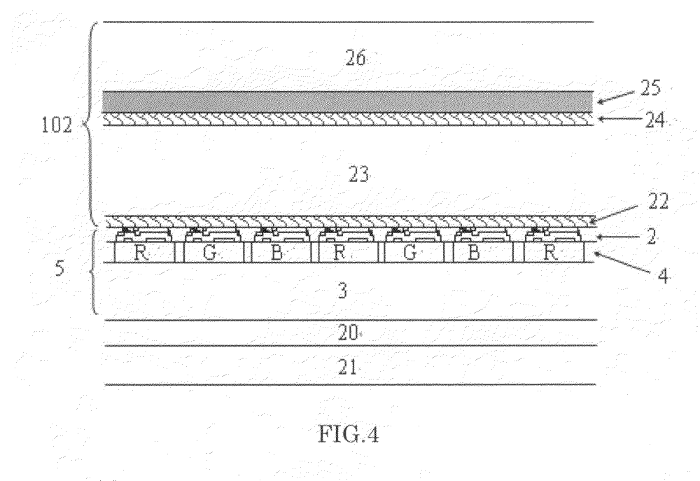

Sectional drawings of an example are shown in FIG. 3 and FIG. 4. FIG. 3 is a partial cross section for approximately 1 pixel of a reflection type display of an example of the present invention. FIG. 4 is a section view of a reflection type display of an example of the present invention.

For substantially transparent plate substrate 3, alkali-free glass 1737 (thickness 0.7 mm) made in Corning were used.

At first, by a spin coat of a red photosensitive coloring composition, a red colored layer was obtained on a substrate. Next, through a photo mask, ultraviolet irradiation of 100 mJ/cm² was performed using an ultra-high pressure mercury lamp. After ultraviolet irradiation, this substrate was soaked in 0.5% sodium carbonate solution for one minute.

Subsequently, by using ion exchanged water, this substrate was washed with water for 30 seconds. This substrate was heat-treated for 20 minutes at 230 degrees Celsius. Red pattern was formed in this way.

Spin coat of a green photosensitivity coloring composition was further performed on the substrate on which a red pattern was formed. Subsequently, same as the above, exposure/developing and heat-treatment of the substrate were performed.

Further, spin coat of a photosensitivity coloring composition of blue was performed on the substrate on which coloring patterns of red and green were formed. Exposure and developing of this substrate were performed.

A color filter having coloring patterns of red, green and blue was obtained in this way.

Then, ITO thin film of 50 nm thickness was formed on a color filter by DC magnetron sputtering technique. The temperature in film formation was room temperature.

And, while position adjustment between the ITO thin film and each pixel of a color filter layer was performed, the ITO thin film was patterned into a desired shape by applying a resist, exposure, etching and exfoliate. In this way, gate electrode 6 and auxiliary capacitor electrode 7 were formed.

After patterning, in order to raise transparency of ITO thin film of a gate electrode and an auxiliary capacitor, anneal in an oven at 150 degrees Celsius for one hour were performed.

Further, SiON thin film of 330 nm thickness was formed thereupon by an RF sputter method using a target of silicon nitride (Si₃N₄).

Gate insulator 8 was formed in this way.

Further, amorphous In—Ga—Zn—O thin film of 40nm thickness was formed by an RF sputter method using a polycrystalline InGaZnO₄ target in order to form semiconductor active layers 11. The amorphous In—Ga—Zn—O thin film was formed under conditions of room temperature.

Afterwards, In—Ga—Zn—O thin film was patterned into a desired shape by applying resist, exposure, developing etching and exfoliate. In this way, a semiconductor active layer was formed.

After having performed resist coating, exposure and developing subsequently, ITO thin film of 50 nm thickness was formed by DC magnetron sputtering technique using ITO ceramic target (In₂O₃-10% SnO₂). The ITO was formed under conditions of room temperature. And, ITO thin film was patterned into a desired shape by lift-off, and thus source electrode 9 and drain electrode 10 was formed. After patterning, anneal in an oven at 150 degrees Celsius for one hour was performed in order to raise transparency of ITO thin film of a source electrode and a drain electrode.

Here, the size of each picture element was a square of 125 μm*125 μm. Channel-length L was 20 μm, and channel width W was 5 μm.

Further, by a printing method, a patterned epoxy system resin of 5 μm thickness was formed.

Interlayer dielectric 12 was formed in this way.

And finally, ITO film of 100 nm thickness was formed under conditions of room temperature by DC magnetron sputtering technique using ITO ceramic target (In₂O₃-10% SnO₂). Pixel electrode 13 was formed by performing resist coating and patterning.

After forming a pixel electrode, anneal in an oven at 150 degrees Celsius for one hour was performed in order to raise transparency of ITO thin film of a pixel electrode.

The semiconductor circuit comprising a substantially transparent thin film transistor and an electric wiring made of substantially transparent conductive material, wherein the wiring had an electrical contact connecting to the thin film transistor, was formed over a color filter while position adjustment between the semiconductor circuit and the color filter's pattern was performed.

A condition of making each film is shown in table 3.

Oriented film 22 was applied on a substantially transparent semiconductor circuit made in this way. In addition, oriented film 24 was applied on alkali-free glass 1737 (thickness 0.5 mm) made in Corning, on which ITO thin film of 70 nm thickness was formed as a common electrode. And the glass with ITO was placed on the substrate with the thin film transistor through a spacer. Then, a liquid crystal is filled between the spacers.

Finally, by placing phase difference plate 20 and polarizer 21 on one side of a substantially transparent substrate 3 where the color filter was not formed, a display of example 3 was manufactured.

Therefore, a display comprises a substantially transparent substrate, a color filter, a semiconductor circuit including a substantially transparent thin film transistor and an electric wiring made of a substantially transparent conductive material, wherein the wiring had an electrical contact with the transistor, and a reflection type display element in this order. In addition, the substantially transparent substrate is placed at a front face side of a display.

TABLE 3

| | | Flow rate of | Flow rate of | Working | Input |
|---|---|---|---|---|---|
| | | Ar | O₂ | pressure | power |
| | Target | [SCCM] | [SCCM] | [Pa] | [W] |
| Gate electrode and | SnO₂: 5 wt. % - | 10 | 0.3 | 0.5 | 200 |
| auxiliary capacitor | In₂O₃ | | | | |
| electrode | | | | | |
| Gate insulator | Si₃N₄ | 40 | 2 | 0.5 | 200 |
| Semiconductor active | InGaZnO₄ | 10 | 0.2 | 0.5s | 200 |
| layer | | | | | |
| Source and Drain | SnO₂: 5 wt. % - | 10 | 0.3 | 0.5 | 200 |
| electrodes | In₂O₃ | | | | |
| Pixel electrode | SnO₂: 5 wt. % - | 10 | 0.2 | 1.0 | 50 |
| | In₂O₃ | | | | |

### EXAMPLE 4

Sectional drawings of an example are shown in FIG. 3 and FIG. 4. FIG. 3 is a partial cross section for approximately 1 pixel of a reflection type display of an example of the present invention. FIG. 4 is a section view of a reflection type display of an example of the present invention.

For substantially transparent plate substrate 3, alkali-free glass 1737 (thickness 0.7 mm) made in Corning were used.

At first, by a spin coat of a red photosensitive coloring composition, a red colored layer was obtained on a substrate. Next, through a photo mask, ultraviolet irradiation of 100 mJ/cm² was performed using an ultra-high pressure mercury lamp. After ultraviolet irradiation, this substrate was soaked in 0.5% sodium carbonate solution for one minute.

Subsequently, by using ion exchanged water, this substrate was washed with water for 30 seconds. This substrate was heat-treated for 20 minutes at 230 degrees Celsius. Red pattern was formed in this way.

Spin coat of a green photosensitivity coloring composition was further performed on the substrate on which a red pattern was formed. Subsequently, same as the above, exposure/developing and heat-treatment of the substrate were performed.

Further, spin coat of a photosensitivity coloring composition of blue was performed on the. substrate on which coloring patterns of red and green were formed. Exposure and developing of this substrate were performed.

A color filter having coloring patterns of red, green and blue was obtained in this way.

Then, ITO thin film of 50 nm thickness was formed on a color filter by DC magnetron sputtering technique. The temperature in film formation was room temperature.

And, while position adjustment between the ITO thin film and each pixel of a color filter layer was performed, the ITO thin film was patterned into a desired shape by applying a resist, exposure, etching and exfoliate. In this way, gate electrode 6 and auxiliary capacitor electrode 7 were formed.

After patterning, in order to raise transparency of ITO thin film of a gate electrode and an auxiliary capacitor, anneal in an oven at 150 degrees Celsius for one hour were performed.

Further, SiON thin film of 330 nm thickness was formed thereupon by an RF sputter method using a target of silicon nitride (Si₃N₄).

Gate insulator 8 was formed in this way.

Further, ZnO thin film of 40 nm thickness was formed by an RF sputter method intentionally using the ZnO target without a dopant in order to form semiconductor active layers 11. The ZnO thin film was formed under conditions of room temperature.

Afterwards, ZnO thin film was patterned into a desired shape by applying resist, exposure, developing etching and exfoliate. In this way, a semiconductor active layer was formed.

After having performed resist coating, exposure and developing subsequently, ITO thin film of 50 nm thickness was formed by DC magnetron sputtering technique using ITO ceramic target (In₂O₃-10% SnO₂). The ITO was formed under conditions of room temperature. And, ITO thin film was patterned into a desired shape by lift-off, and thus source electrode 9 and drain electrode 10 was formed. After patterning, anneal in an oven at 150 degrees Celsius for one hour was performed in order to raise transparency of ITO thin film of a source electrode and a drain electrode.

Here, the size of each picture element was a square of 125 μm*125 μm. Channel-length L was 20 μm, and channel width W was 5 μm.

Further, by a printing method, a patterned epoxy system resin of 5 μm thickness was formed.

Interlayer dielectric 12 was formed in this way.

And finally, ITO film of 100 nm thickness was formed under conditions of room temperature by DC magnetron sputtering technique using ITO ceramic target (In₂O₃-10% SnO₂). Pixel electrode 13 was formed by performing resist coating and patterning.

After forming a pixel electrode, anneal in an oven at 150 degrees Celsius for one hour was performed in order to raise transparency of ITO thin film of a pixel electrode.

The semiconductor circuit comprising a substantially transparent thin film transistor and an electric wiring made of substantially transparent conductive material, wherein the wiring had an electrical contact connecting to the thin film transistor, was formed over a color filter while position adjustment between the semiconductor circuit and the color filter's pattern was performed.

A condition of making each film is shown in table 4.

Oriented film 22 was applied on a substantially transparent semiconductor circuit made in this way. As conductive substrate 27, tinfoil (thickness 25 μm) was further prepared. Oriented film 24 was applied on the tinfoil.

The substrate with the semiconductor circuit was placed over this tinfoil through a spacer. Liquid crystal was filled between the spacers afterwards. Finally, phase difference plate 20 and polarizer 21 were placed over one side of a substantially transparent substrate, where a color filter was not formed. In this way, a display of example 4 was manufactured.

Therefore, a display comprises a substantially transparent substrate, a color filter, a semiconductor circuit including a substantially transparent thin film transistor and an electric wiring made of a substantially transparent conductive material, wherein the wiring had an electrical contact with the transistor, and a reflection type display element in this order. In addition, the substantially transparent substrate is placed at a front face side of a display.

TABLE 4

| | | Flow | Flow | | |
|---|---|---|---|---|---|
| | | rate of | rate of | Working | Input |
| | | Ar | O₂ | pressure | power |
| | Target | [SCCM] | [SCCM] | [Pa] | [W] |
| Gate electrode and | SnO₂: 5 wt. % - | 10 | 0.3 | 0.5 | 200 |
| auxiliary capacitor | In₂O₃ | | | | |
| electrode | | | | | |
| Gate insulator | Si₃N₄ | 40 | 2 | 0.5 | 200 |
| Semiconductor active | ZnO | 12 | 0.1 | 0.5 | 200 |
| layer | | | | | |
| Source and Drain | SnO₂: 5 wt. % - | 10 | 0.3 | 0.5 | 200 |
| electrodes | In₂O₃ | | | | |

### EXAMPLE 5

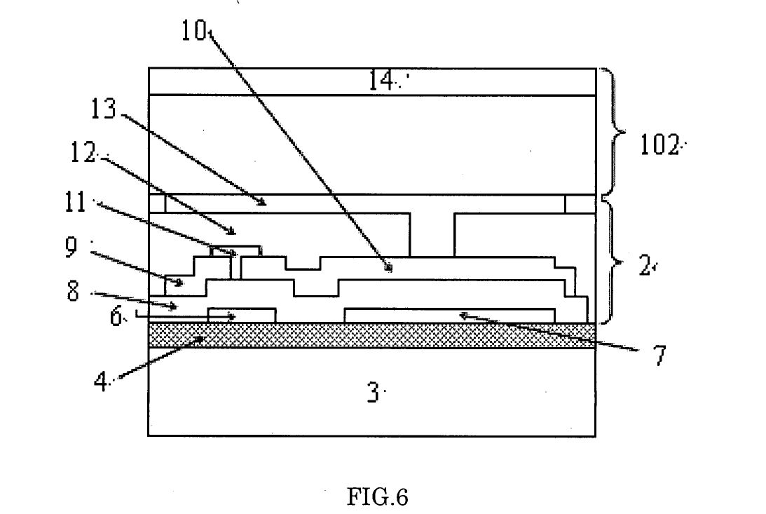

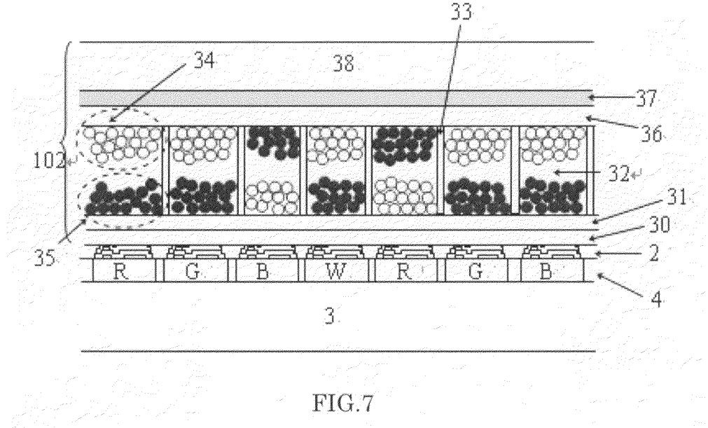

Sectional drawings of an example are shown in FIG. 6 and FIG. 7. FIG. 6 is a partial cross section for approximately 1 pixel of a reflection type display of an example of the present invention. FIG. 7 is a section view of a reflection type display of an example of the present invention.

A PEN film (Q65 made in Teijin Corporation: thickness 100 μm) was used as substantially transparent plate substrate 3. Color filter layer 4 of R (red), G (green) and B (blue) was formed on one side of substrate 3. A protective layer comprising a transparent resin was formed thereupon.

Then, ITO thin film of 50 nm thickness was formed over color filter layer by DC magnetron sputtering technique. And, the ITO thin film was patterned into a desired shape while position adjustment between the patterned ITO thin film and a color filter layer was performed. In this way, gate electrode 6 and auxiliary capacitor electrode 7 were formed. Further, using a target of silicon nitride (Si₃N₄), SiON thin film of 150 nm thickness was formed thereupon by RF sputter method. Gate insulator 8 was formed in this way.

ITO film of 50 nm thickness was formed thereupon by DC magnetron sputtering technique. By patterning of ITO film, source electrode 9 and drain electrode 10 were formed.

Afterwards, semiconductor active layer 11 was formed by forming pentacene of 50 nm thickness by evaporation method.

Further, a patterned epoxy system resin of 5 μm thickness was formed by a printing method. Interlayer dielectric 12 was formed in this way.

And finally, ITO of 100 nm thickness was formed by DC magnetron sputtering technique. Pixel electrode 13 was formed by performing patterning of ITO.

A condition of making each film is shown in table 5.

The semiconductor circuit comprising a substantially transparent thin film transistor and an electric wiring made of substantially transparent conductive material, wherein the wiring had an electrical contact connecting to the thin film transistor, was formed over a color filter while position adjustment between the semiconductor circuit and the color filter's pattern was performed.

Next, electrode 37 of 50 nm thickness was formed by evaporation method on a PEN film (Q65 made in Teijin Corporation: thickness 100 μm). Insulating film 2 of 150 nm thickness comprising Y₂O₃ was formed thereupon by evaporation method. Then, Rib 33 was formed thereupon. In this way, a space partitioned by rib 33, of which size is same as the size of thin film transistor 2, is made.

White color particle 34 negatively charged by the friction and black particle 35 positively charged by the friction were put inside the space.

And a display of example 5 was made by attaching the PEN film with the space and the particles to the color filter while position adjustment was performed.

Therefore, a display comprises a substantially transparent substrate, a color filter, a semiconductor circuit including a substantially transparent thin film transistor and an electric wiring made of a substantially transparent conductive material, wherein the wiring had an electrical contact with the transistor, and a reflection type display element in this order. In addition, the substantially transparent substrate is placed at a front face side of a display.

TABLE 5

| | | | Flow | | |
|---|---|---|---|---|---|
| | | Flow rate of | rate of | Working | Input |
| | | Ar | O₂ | pressure | power |
| | Target | [SCCM] | [SCCM] | [Pa] | [W] |
| Gate electrode and | SnO₂: 5 wt. % - | 10 | 0.3 | 0.5 | 200 |
| auxiliary capacitor | In₂O₃ | | | | |
| electrode | | | | | |
| Gate insulator | Si₃N₄ | 40 | 2 | 0.5 | 200 |
| Source and Drain | SnO₂: 5 wt. % - | 10 | 0.3 | 0.5 | 200 |
| electrodes | In₂O₃ | | | | |
| Pixel electrode | SnO₂: 5 wt. % - | 10 | 0.2 | 1.0 | 50 |
| | In₂O₃ | | | | |

As shown in examples 3, 4 and 5, a substantially transparent semiconductor circuit was formed on a substantially transparent substrate, and the members were placed in front of a reflection type display element.

Thus, a reflection type display, wherein manufacturing cost is low and position adjustment between a color filter and a semiconductor circuit is easy, can be obtained.

Based on the above explanation, a person skilled in art can perform upgrade and modification of the above mentioned example within the present invention.

What is claimed is:

1. A structure comprising:
a color filter; and
a substantially transparent semiconductor circuit on a surface of the color filter.

2. A structure according to claim 1, further comprising
an overcoat on the color filter wherein the substantially transparent semiconductor circuit is on a surface of the overcoat.

3. A transmission type liquid crystal display comprising:
the structure according to claim 1; and
a transmission type liquid crystal display element on one side of the substantially transparent semiconductor circuit, wherein there is no color filter on the one side.

4. A transmission type liquid crystal display comprising:
the structure according to claim 2; and
a transmission type liquid crystal display element on one side of the substantially transparent semiconductor circuit, wherein there is no color filter on the one side.

5. A method of manufacturing a structure comprising:
preparing a color filter; and
forming a substantially transparent semiconductor circuit on a surface of the color filter while position adjustment between the color filter and the semiconductor circuit is performed.

6. A method of manufacturing a structure according to claim 5, comprising:
preparing the color filter with an overcoat; and
forming the substantially transparent semiconductor circuit on a surface of the overcoat while position adjustment between the color filter and the semiconductor circuit is performed.

7. A method of manufacturing a transmission type liquid crystal display comprising:
preparing the structure by the method according to claim 5; and
forming a transmission type liquid crystal display element on one side of the substantially transparent semiconductor circuit, wherein there is no color filter on the one side.

8. A method of manufacturing a transmission type liquid crystal display comprising:
preparing the structure by the method according to claim 6; and
forming a transmission type liquid crystal display element on one side of the substantially transparent semiconductor circuit, wherein there is no color filter on the one side.

9. A reflection type display comprising:
the structure according to claim 1; and
a reflection type display element on one side of the substantially transparent semiconductor circuit, wherein there is no color filter on the one side.

10. A reflection type display comprising:
the structure according to claim 2; and
a reflection type display element on one side of the substantially transparent semiconductor circuit, wherein there is no color filter on the one side.

11. A method of manufacturing a reflection type display comprising:
preparing the structure by the method according to claim 5; and
forming a reflection type display element on one side of the substantially transparent semiconductor circuit, wherein there is no color filter on the one side.

12. A method of manufacturing a reflection type display comprising:
preparing the structure according to claim 6; and
forming a reflection type display element on one side of the substantially transparent semiconductor circuit, wherein there is no color filter on the one side.
